(19) United States
(12) Patent Application Publication
(10) Pub. No.: US 2016/0189110 A1
(43) Pub. Date: Jun. 30, 2016

(54) Location Information for Meeting Enhancement

(71) Applicants: Jens Bombolowsky, Schwetzingen (DE); Ingrid Bernaudin, South San Francisco (CA)

(72) Inventors: Jens Bombolowsky, Schwetzingen (DE); Ingrid Bernaudin, South San Francisco (CA)

(21) Appl. No.: 14/585,694

(22) Filed: Dec. 30, 2014

(51) Int. Cl. G06Q 10/10

(52) U.S. Cl. CPC G06Q 10/1095

(57) ABSTRACT

Meeting organization and execution can be improved through the addition of invited participant location information, which can optionally be derived based on geo-location information accessed from at least one computing device used by the invited participant. Based on comparisons with meeting location information, participant status, including improved predictions of who will attend and how soon one or more participants will arrive can be generated for display in a user interface. In optional implementations, a meeting scheduling process can be improved by incorporation of current location information for one or more invited participants.

### TECHNICAL FIELD

The subject matter described herein relates to computer-implemented functionality relating to meeting organization, scheduling, and the like.

### BACKGROUND

Efficient scheduling, planning, organization, and execution of meetings can be an important factor in ensuring optimal productivity among team members or other collaborating individuals. A meeting can include in-person interactions between two or more attendees at a same location (e.g. in a meeting room, an office, etc.) as well as between attendees who are not co-located, such as for example attendees in two or more different physical locations. Attendees in different physical locations may participate in a meeting by telephone conference, by videoconference, by use of a networked meeting portal (e.g. a web meeting, such as those supported by Adobe Connect available from Adobe Systems of Mountain View, Calif.; Webex available from Cisco Systems of San Jose, Calif., etc.), or the like.

Some existing calendaring and meeting organization applications can provide assistance in meeting scheduling based on comparison of available time periods in potential participants' daily schedules. For example, a first potential participant may have meetings or appointments or other periods of unavailability marked on his or her calendar between 8 AM and noon on Monday while a second potential participant may have meetings or appointments or other periods of unavailability marked on his or her calendar between 2 PM and 4 PM on Monday. A conventional meeting organization application could suggest scheduling of a meeting to include the first and second participants between noon and 2 PM or after 4 PM on Monday.

### SUMMARY

In various implementations of the current subject matter, meeting enhancement functionality can provide useful, timely information to a meeting organizer and optionally to other participants in a meeting regarding one or more of current locations of other meeting participants at or near the time of the meeting. The provided information can optionally include indications of invited participants' likely ability to participate in the meeting, proximity to a physical meeting location, access to network or telephone resources necessary to participate in a meeting remotely, etc.

Implementations of the current subject matter can include, but are not limited to, systems and methods including one or more features described herein as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating aspects of a method having one or more features consistent with implementations of the current subject matter;

FIG. 2, FIG. 3, and FIG. 4 show examples of screenshot views illustrating features consistent with implementations of the current subject matter; and

FIG. 5 is a diagram illustrating aspects of a system showing features consistent with implementations of the current subject matter.

When practical, similar reference numbers denote similar structures, features, or elements.

### DETAILED DESCRIPTION

Current approaches to meeting organization generally involve sharing of calendar information, disseminating of electronic invitations by a meeting organizer or a delegate of a meeting organizer, etc. However, many of the tasks and requirements for determining a preferred meeting time and location, identifying those invited participants who should be able to attend the meeting, providing information on whether invited participants who previously indicated that they would attend will actually be present (e.g. in-person, by phone, by video link, over a networked meeting portal, etc.) for the meeting, and the like are typically performed manually and without leveraging available additional information sources.

It can be desirable for meeting participants, including the meeting organizer and optionally other participants, to have access to enhanced information about other invited participants to the meeting. This enhanced information can include one or more of a current location of an invited participant, an indication of an estimated likelihood of the invited participant actually attending or otherwise participating in the meeting, and optionally additional details including but not limited to those discussed below.

In some implementations of the current subject matter, meeting enhancement functionality, which can optionally be provided by a networked meeting enhancement software application, can analyze invited participant information relating to upcoming meetings or meeting requests on a calendar or other scheduling application accessible by a meeting organizer and optionally by other invited participants to a meeting. A meeting in this context refers to a scheduled collaboration event or other gathering to which one or more invited participants have been invited. The invited participants can choose to accept or decline a meeting request related to the meeting, or in some examples indicate a tentative “yes” or “no.” Invited participants can intend to participate in the meeting by any feasible mode of attendance (e.g. in person, by telephone or videoconference, by use of a networked meeting portal, etc.). A meeting request can refer to an invitation sent to an invited participant from a meeting organizer or a delegate of a meeting organizer that has or has not been accepted by an invited participant. Participant information can include one or more of participant profile information (e.g. contact information such as a mobile phone number, or the like), participant skills, conversations in which the participant is participating or has participated within some period of time, other useful participant data relating to or representative of meeting participants or invitees, etc. Participant information such as one or more of the options listed here can enable a meeting organizer to prepare a meeting more efficiently and also potentially to improve outcomes when the meeting is conducted.

Meeting enhancement functionality consistent with implementations of the current subject matter can provide information regarding whether an invited participant plans to attend or not, based on the information received in the original meeting request. A meeting request can optionally be sent by a meeting organizer from within an instance of a meeting enhancement software application or optionally via some other tool or application. The instance of the meeting enhancement software application can be executed on any kind of computing device that can communicate with one or more servers and/or networked database. Other tools or applications can optionally include a meeting organization application, a calendaring application, or the like, such as for example Outlook available from Microsoft Corporation of Redmond, Wash., etc. In currently available approaches, information about an invited participant's intent to attend the meeting is available only to the extent that the invited participant provides such information, for example by accepting a meeting invitation, enabling a setting whereby an assistant or other delegate can accept a meeting invitation on the invited participant's behalf, enabling a setting whereby incoming meeting invitations are automatically accepted and placed on the invited participant's calendar, etc.

In some scenarios, information about an invited participant's intention to attend a meeting can be insufficient to provide a current, realistic characterization of the likelihood of the invited participant actually attending that meeting. Various devices, including personal computers, laptops, mobile phones, tablet computers, and the like, can include software applications designed to organize calendar appointments and provide reminders to a user regarding scheduled meetings, meetings that the user has indicated an intention to attend, etc. However, any of a number of factors can interfere with an invited participant's ability or willingness to participate in a meeting at the originally scheduled time, even if the invited participant had originally accepted a meeting invitation. In some cases, an invited participant who had previously accepted a meeting invitation may forget or be otherwise unable or unwilling to change an original acceptance of the meeting to indicate that he or she no longer intends to participate.

To address these and potentially other deficiencies in currently available approaches to meeting planning, organizing, and the like, implementations of the current subject matter can make use of additional information about participants to leverage additional information about an invited participant to better inform scheduling decisions for meetings as well as to provide more accurate information about a likelihood and an expected timing of an invited participant actually joining a meeting. One or more computing devices used by an invited participant to a meeting can provide the additional information. Such computing devices can include personal desktop or laptop computers, mobile phones, tablet computers, personal digital assistants, or the like. The additional information can optionally include one or more of location information, current activity information, online activity information, movement information, etc.

Computer-implemented meting enhancement functionality (referred to herein generally as meeting enhancement functionality) consistent with implementations of the current subject matter can include capabilities relating to tracking or otherwise estimating one or more of a current location of an invited meeting participant, a predicted location of an invited meeting participant, etc. Additionally or in the alternative, meeting enhancement functionality can include capabilities relating to estimating or predicting whether an invited meeting participant is likely to actually participate in a meeting based on current or predicted location information about the invited participant. To address privacy concerns, a user of meeting enhancement functionality such as is described herein can have the ability to permit or not permit certain types of information about his or her location or activities to be shared.

The meeting enhancement functionality can estimate or otherwise access stored and periodically updated location information about an invited participant, such as for example geo-location information. In other examples, current location information can be queried and updated periodically, upon a request received from a meeting organizer or other authorized user to refresh the information, etc. Location information of an invited participant can optionally be made available to the meeting enhancement functionality only if such access is approved by the invited participant, for example via a configurable software or hardware setting, by a response from the invited participant to a request displayed or otherwise conveyed via a user interface or the like, etc.

Geo-location information can take one or more of many forms and can be derived from one or more of many sources consistent with the current subject matter. For example, location information can be obtained from an invited participant's personal mobile device, such as a location-enabled smart phone, cellular phone, tablet computer, or the like that includes one or more geo-location capabilities. Geo-location capabilities can make use of global positioning system (GPS) data or other satellite-based or terrestrial reference point information, such as for example the Russian GLONASS system, the Galileo system being developed by the European Space Agency, cellular phone or other wide area network signals referenced to transceiver tower locations, WiFi network connection data and a location of the corresponding WiFi transceiver, computer identifiers (for example a media access control or MAC address or the like) associated with physical locations (for example for desktop machines or other computing devices that have relatively fixed physical locations), and any other technology capable of determining a location (either relative to some reference point or in absolute terms relative to a common set of coordinates) of a computing device.

While geo-location information can typically be quite accurate with regards to a device such as those discussed above, the personal location of the actual invited participant is typically of greater utility than a location of one or more of his or her devices. Accordingly, the meeting enhancement functionality can optionally make use of additional participant-device proximity information or estimation approaches to better inform an estimate of the invited participant's location based on locations for one or more devices owned by, used by, assigned to, etc. the invited participant. For example, a weighting factor or other, more complicated function or expression can be assigned to a specific device or type of device based on a relative expectation of a specific device or type of device moving with its user independent of whether the user is actively using the device. For example, a smart phone, cellular phone, or other personal communication device might be expected to have a relatively high correlation between its current location and that of its primary user, even when the user is not actively using the device. At another extreme, a desktop computer might be expected to have a relatively low correlation between its current location and that of its primary user except when the primary user is actively using the desktop computer. Possession and/or use of a device can be determined based on any criteria capable of establishing some confidence that a user is currently in possession of the device or otherwise co-located with it. Example criteria can be a current state of being logged in to the device (for example by having entered a security code or other log-in information within some defined time period), user-initiated network activity to or from the device within some amount of time, etc.

The meeting enhancement functionality can optionally make use of one or more databases that store and periodically update geo-location information for invited participants to a meeting. For example, in some implementations a participant profile can be created and maintained within the database and updated with current geo-location information about the participant. As this kind of participant profile could be considered overly intrusive or contrary to privacy concerns of individual participants, other approaches are also within the scope of the current subject matter. For example, geo-location information about an invited participant can be requested by sending an alert or a request for a current status or location to one or more devices of the invited participant. To avoid excessive intrusiveness, in some examples only a meeting organizer can be able to request such information. In other examples, a larger group, optionally including all invited participants, can access this information.

As an example, invited participants who use the meeting enhancement functionality, for example by using a meeting enhancement software application running on one or more computing devices of the invited participant, can be requested by the meeting enhancement software application to allow access to geo-location information for the invited participant. The geo-location information can in some examples be used by the meeting enhancement software application itself, to identify where the invited participant is currently located. Through sharing of this information for multiple invited participants, optionally via a networked architecture, locations of one or more invited participants can be compared with a physical location of the meeting. A physical location of the meeting can optionally include a building, a part of a building where a meeting room for the meeting is located, the actual meeting room itself, etc. For distributed meetings (e.g. meetings in which participants are not all in the same physical location) the current location of an invited participant can be compared to the location of multiple meeting rooms or other facilities via which an invited participant might join the meeting (e.g. telephone links, video conference hardware, a networked connection capable of supporting a networked meeting portal, etc.).

Using the aforementioned information, meeting enhancement functionality can aggregate and provide information regarding invited participants who are already in the meeting room or rooms (and if multiple rooms are being used, which room an invited participant is in). Additionally, information can be provided regarding a current distance of an invited participant from a meeting location or meeting access point, whether an invited participant who is not currently at meeting location or meeting access point is moving toward the meeting location or meeting access point, an estimated arrival time of the invited participant who is not at a meeting location or meeting access point but currently in motion, etc. An invited participant who is not at a meeting location or meeting access point and is not moving when the meeting start time is reached or approached can be indicated as possibly having forgotten the meeting. If an invited participant is indicated as currently using a computer but not at a physical meeting location, that invited participant can be indicated as potentially needing to join the meeting by a remote access mode (e.g. telephone, video conference, networked meeting portal, etc.). The meeting organizer can be prompted to send the necessary remote access information to enable the invited participant to join.

An organizer and optionally other meeting participants can also be provided with information about the current time in various other participants' current location, which can allow temporally appropriate greetings (e.g. “Good morning” to participants in Australia, “Good evening” to a participant in Utah, etc.). The meeting enhancement functionality can also provide other information such as whether an invited participant is attending from home or from the road, how long it might take the invited participant to get into the meeting room physically, etc.

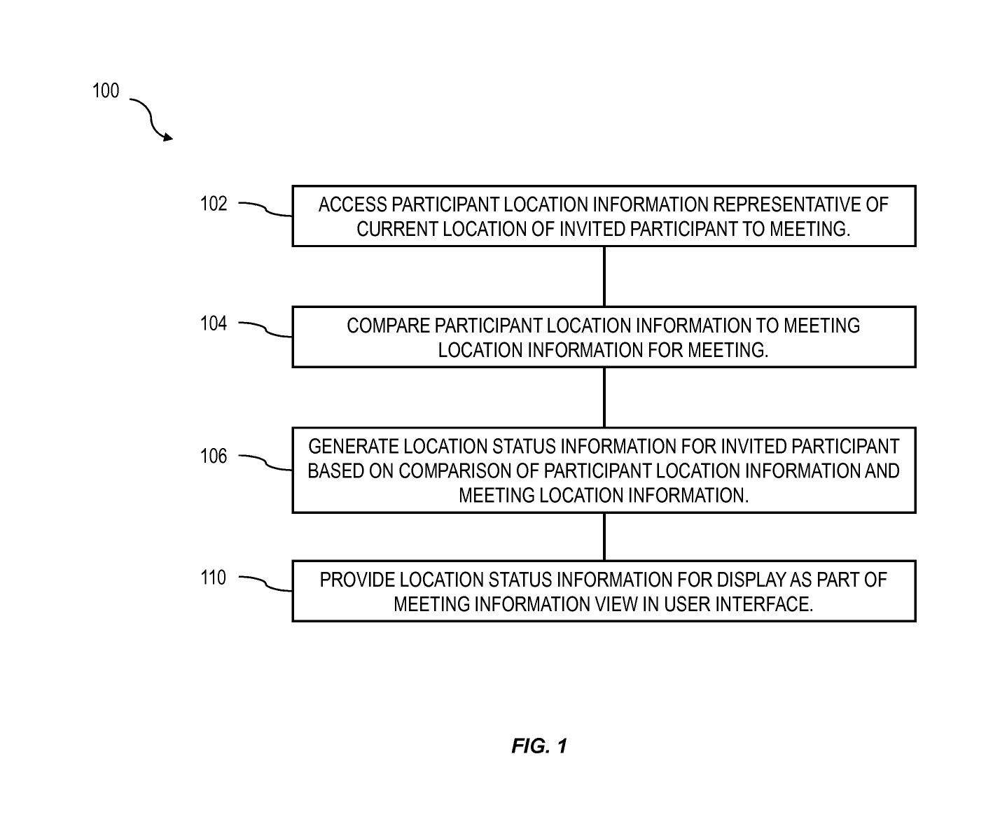

FIG. 1 shows a process flow chart 100 illustrating features of a method consistent with implementations of the current subject matter. At 102, participant location information representative of a current location of an invited participant to a meeting is accessed. This participant location information can be accessed using one or more approaches, which can include but are not limited to those examples discussed herein. For example, the participant location information can be accessed by querying at least one computing device used by the invited participant for geo-location information. In some examples, the geo-location information can be modified based on an expected current proximity of the at least one computing device to the invited participant.

At 104, the participant location information is compared to meeting location information for the meeting. The meeting location information can include physical locations of one or more meeting rooms for the meeting. Meeting location information can also or alternatively include network, video conferencing, or telephone connection availability that could be available to the invited participant based on the participant location information.

At 106, based on the comparison of the participant location information and the meeting location information, location status information can be generated for the invited participant. The generated location status information can be provided at 110 for display to a user via a user interface as part of a meeting information view for the meeting. Optionally, additional invited participant location status detail information can be provided for display in the user interface upon receipt of a user command requesting the additional invited participant location status detail information.

In some implementations of the current subject matter, meeting enhancement functionality can propose optimized meeting timings for scheduling or rescheduling a meeting. Such proposals can make use of information available from current approaches (e.g. open periods of availability on an invited participant's calendar) but further enhanced with knowledge based on desired participants' current locations and the associated time zones, etc. For example, a meeting time for the meeting can be proposed based on a calendar availability of the invited participant and the participant location information. The participant location information can indicate that the invited participant is in a specific time zone in which the invited participant's working hours are defined. A proposed time for the meeting would take into account this information to not propose meeting times that are outside of the preferred working hours in the invited participant's current time zone.

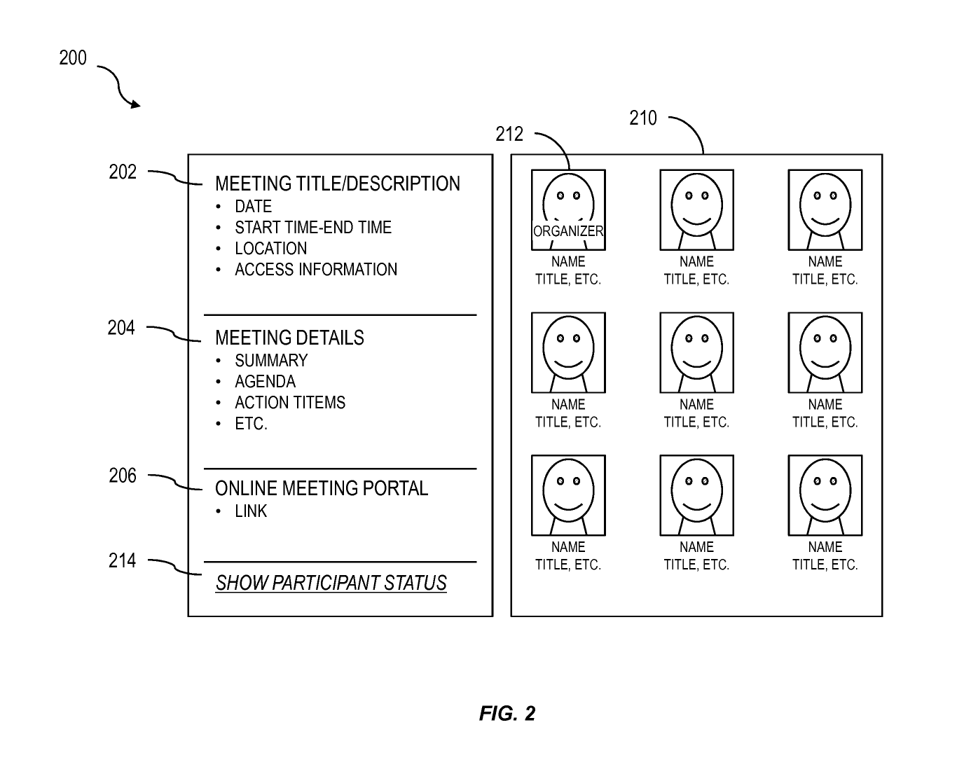

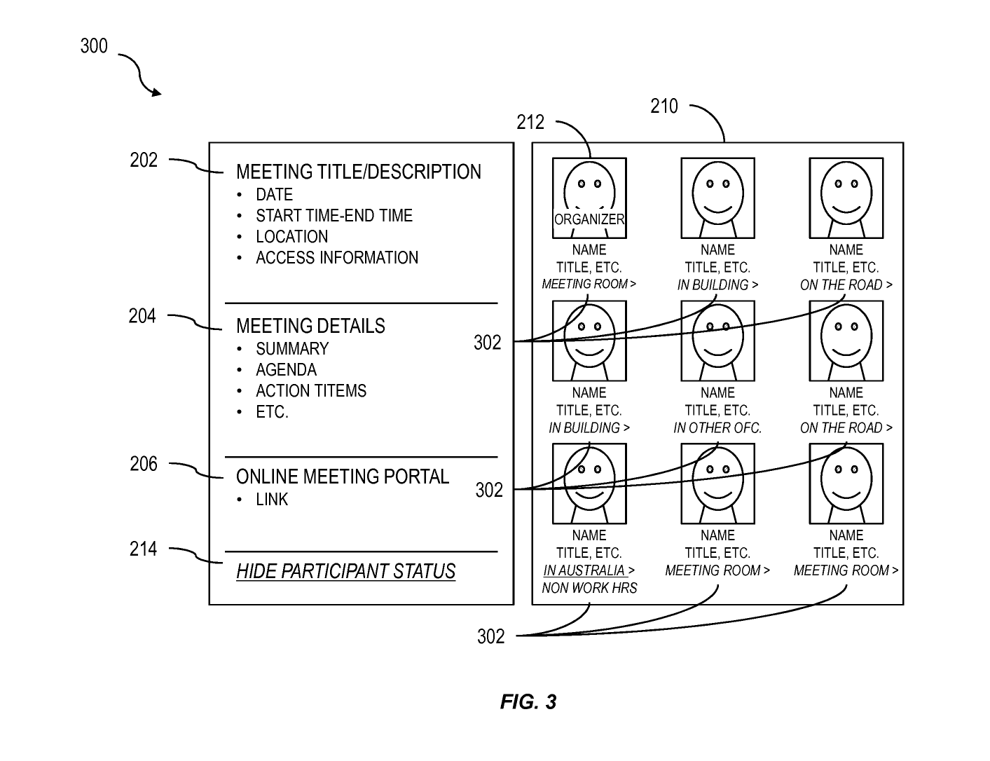

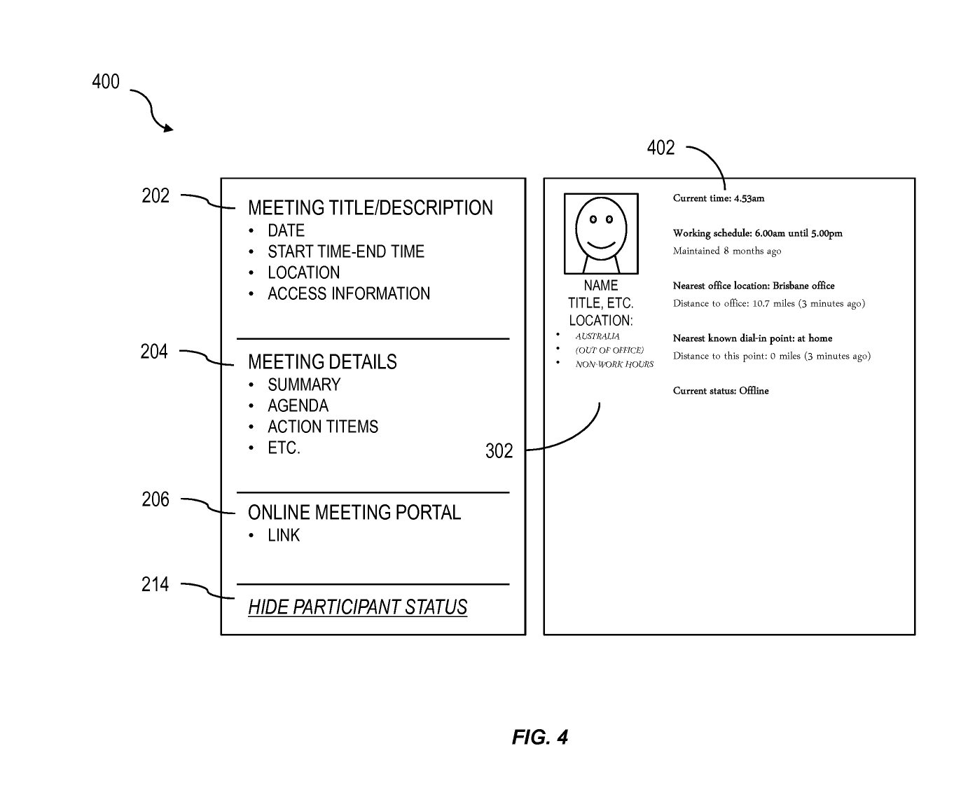

FIG. 2, FIG. 3, and FIG. 4 show screenshot views 200, 300, and 400 illustrating features consistent with implementations of the current subject matter. As shown in FIG. 2, a user interface display can include a meeting summary information 202, meeting detail information 204, links or other connection information 206 to enable remote access to a meeting, and meeting participant information 210. The meeting participant information can optionally include a display of basic information for each invited participant, optionally including one or more of a picture, a name, a title, etc. of the invited participant. A meeting organizer 212 can be marked accordingly. A link or other user interface element 214 can also be displayed to trigger display of invited participant status information.

As shown in the screenshot view 300 of FIG. 3, selection of the “show participant status” element 214 can cause participant location information 302 to be displayed for the invited participants. Participant location information in this example can include information such as “meeting room” to indicate that the invited participant is physically in the meeting room, “in building” to indicate that the invited participant is not yet in the meeting room but nearby and at least in the same building or otherwise relatively close to the meeting room, “on the road” to indicate that the invited participant is not in the office and therefore unlikely to physically attend the meeting, “in another office” to indicate that the invited participant is not in the same physical location as one meeting room but perhaps close to another meeting room location for a distributed meeting, etc. In the example of FIG. 3, one participant's participant location information indicate “in Australia” and “out of office” indicating that the invited participant is in a different time zone where it is not currently working hours. Such an invited participant might not be expected to participate in the meeting.

The participant location information 302 can optionally be “clickable” or otherwise linked to a detail page, such as for example that shown in the screenshot view 400 of FIG. 4. The participant location information 302 can be displayed along with greater detail 402 (e.g. additional invited participant location status detail information) about location of meeting attendance status of a selected invited participant. The greater detail 402 can optionally include one or more of a current time at the invited participant's current location, the invited participant's working schedule in his or her current time zone, a current distance of the invited participant from an office location, a nearest known dial-in or networked location and current distance to that dial-in or networked location, a current online or offline status, etc.

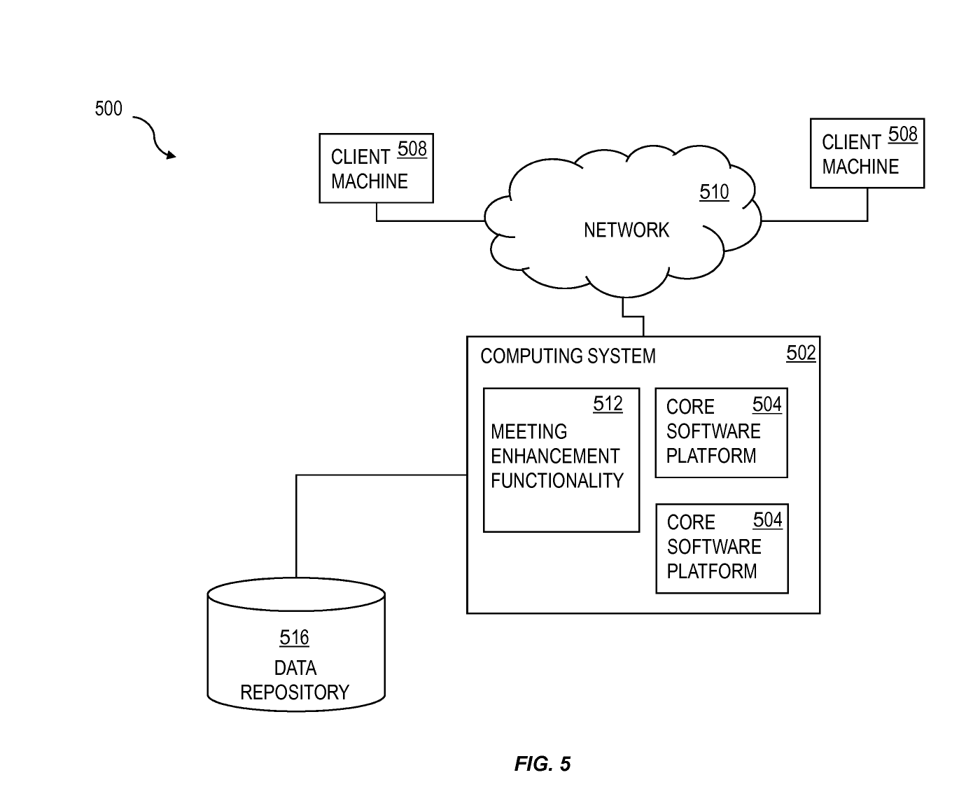

FIG. 5 shows a diagram of a system consistent with such one or more implementations of the current subject matter. A computing system 502 can include one or more core software platform modules 504, which can optionally provide one or more features of a business software system or the like. As used herein, a business software system can include functionality such as enterprise resource planning (ERP), customer relationship management (CRM), calendaring and scheduling, time management, etc. Client machines 508 can access the computing system 502, either via a direct connection, a local terminal, or over a network 510 (e.g. a local area network, a wide area network, a wireless network, the Internet, or the like). Meeting enhancement functionality 512 can be hosted on the computing system 502 or alternatively, on an external system accessible over a network connection. The meeting enhancement functionality 512 can optionally include one or more discrete software and/or hardware modules that perform operations such as those described herein. The meeting enhancement functionality 512 can optionally access one or more data repositories 516 that can store information applicable in making estimates of a location of an invited participant to a meeting, a likelihood of an invited participant attending a meeting, other information relevant to improving efficiency of organizing or conducting a meeting, or the like.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
accessing participant location information representative of a current location of an invited participant to a meeting;
comparing the participant location information to meeting location information for the meeting;
generating location status information for the invited participant based on the comparing of the participant location information and the meeting location information; and
providing location status information for display in a user interface as part of a meeting information view for the meeting.

2. A computer program product as in claim 1, wherein the accessing of the participant location information comprises querying at least one computing device used by the invited participant for geo-location information.

3. A computer program product as in claim 2, wherein the accessing of the participant location information further comprises modifying the geo-location information based on an expected current proximity of the at least one computing device to the invited participant.

4. A computer program product as in claim 1, wherein the meeting location information comprises one or more of a physical location of at least one meeting room for the meeting and availability of network, video conferencing, or telephone connections to the invited participant based on the participant location information.

5. A computer program product as in claim 1, wherein the operations further comprise providing additional invited participant location status detail information upon receipt of a user command requesting the additional invited participant location status detail information.

6. A computer program product as in claim 1, wherein the operations further comprise proposing a meeting time for the meeting based on a calendar availability of the invited participant and the participant location information.

7. A system comprising:
at least one programmable processor; and
a machine-readable medium storing instructions that, when executed by the at least one processor, cause the at least one programmable processor to perform operations comprising:
accessing participant location information representative of a current location of an invited participant to a meeting;
comparing the participant location information to meeting location information for the meeting;
generating location status information for the invited participant based on the comparing of the participant location information and the meeting location information; and
providing location status information for display in a user interface as part of a meeting information view for the meeting.

8. A system as in claim 7, wherein the accessing of the participant location information comprises querying at least one computing device used by the invited participant for geo-location information.

9. A system as in claim 8, wherein the accessing of the participant location information further comprises modifying the geo-location information based on an expected current proximity of the at least one computing device to the invited participant.

10. A system as in claim 7, wherein the meeting location information comprises one or more of a physical location of at least one meeting room for the meeting and availability of network, video conferencing, or telephone connections to the invited participant based on the participant location information.

11. A system as in claim 7, wherein the operations further comprise providing additional invited participant location status detail information upon receipt of a user command requesting the additional invited participant location status detail information.

12. A system as in claim 7, wherein the operations further comprise proposing a meeting time for the meeting based on a calendar availability of the invited participant and the participant location information.

13. A computer-implemented method comprising:
accessing participant location information representative of a current location of an invited participant to a meeting;
comparing the participant location information to meeting location information for the meeting;
generating location status information for the invited participant based on the comparing of the participant location information and the meeting location information; and
providing location status information for display in a user interface as part of a meeting information view for the meeting.

14. A computer-implemented method as in claim 13, wherein the accessing of the participant location information comprises querying at least one computing device used by the invited participant for geo-location information.

15. A computer-implemented method as in claim 14, wherein the accessing of the participant location information further comprises modifying the geo-location information based on an expected current proximity of the at least one computing device to the invited participant.

16. A computer-implemented method as in claim 13, wherein the meeting location information comprises one or more of a physical location of at least one meeting room for the meeting and availability of network, video conferencing, or telephone connections to the invited participant based on the participant location information.

17. A computer-implemented method as in claim 13, wherein the operations further comprise providing additional invited participant location status detail information upon receipt of a user command requesting the additional invited participant location status detail information.

18. A computer-implemented method as in claim 13, wherein the operations further comprise proposing a meeting time for the meeting based on a calendar availability of the invited participant and the participant location information.

19. A computer-implemented method as in claim 13, wherein at least one of the accessing, the comparing, the generating, and the providing is performed by at least one programmable processor.
